(19) United States
(12) Patent Application Publication
(10) Pub. No.: US 2004/0157333 A1
(43) Pub. Date: Aug. 12, 2004

(54) Methods of analyzing microporous polyolefin film pore structure and three-dimensional images thereof

(76) Inventors: Larry H. McAmish, Cincinnati, OH (US); David L Green, Heverlee (BE)

Correspondence Address: DINSMORE & SHOHL, LLP, 1900 CHEMED CENTER, 255 EAST FIFTH STREET, CINCINNATI, OH, 45202, US

(21) Appl. No.: 10/701,695

(22) Filed: Nov. 5, 2003

Related U.S. Application Data
(60) Provisional application No. 60/423,833, filed on Nov. 5, 2002.
(60) Provisional application No. 60/444,579, filed on Feb. 3, 2003.

(51) Int. Cl. G01N 21/00

(52) U.S. Cl. 436/5; 436/164

(57) ABSTRACT

Methods of analyzing pore structure in a microporous polyolefin film comprise applying a detectable material to one surface of a microporous polyolefin film, wherein the detectable material is capable of traveling through pores in the film, and focusing a confocal microscope at a depth within the film to obtain a first image of the detectable material within pores of the film at the depth within the film. Three-dimensional images of pore structure within a microporous polyolefin film comprise a plurality of aligned confocal microscope images wherein each confocal microscope image comprises a two-dimensional image of pore structure at a depth within the film.

### RELATED APPLICATIONS

This application claims priority under 35 U.S.C. § 119 of U.S. Applications Serial Nos. 60/423,833 filed Nov. 5, 2002 and 60/444,579 filed Feb. 3, 2003.

### FIELD OF THE INVENTION

The present invention is directed to methods of analyzing pore structure and microporous polyolefin films, for example microporous films formed by stretching a film comprising polyolefin polymer and filler. The methods employ confocal microscopy. The invention is also directed to three-dimensional images of pore structure within microporous polyolefin films.

### BACKGROUND OF THE INVENTION

Microporous polyolefin films are well known in the art and are typically formed by stretching of a film formed from a composition comprising polyolefin and at least one filler. In one method, a film formed from such a composition is subjected to incremental stretching whereupon pores are formed adjacent filler particles throughout the film. The Wu U.S. Pat. No. 5,865,926 discloses various embodiments of such methods.

The production of such films can be controlled in order to provide a pore structure which renders the films porous and breathable, i.e., permeable to air and water vapor, while maintaining liquid impermeability of the film. Such breathable films may be used alone or in combination with other materials as composites in various applications where breathable, yet liquid impermeable, properties are desired. Conventionally, such materials may be commonly employed in disposable garments, for example diapers and protective wear, hygiene products, including feminine hygiene products, construction materials, for example housewrap, among many other known applications. It will be appreciated that depending on a particular application of such films, variations in air and water permeability, liquid barrier properties and the like may be desired in order to tailor the films to a particular use. Accordingly, it would be advantageous to be able to analyze pore structure, and particularly pore connectivity in such films, in order to provide further control of the parameters which influence pore structure in such films.

### SUMMARY OF THE INVENTION

Accordingly, it is an object of the present invention to provide methods of analyzing pore structure in microporous polyolefin films. It is also an object to provide methods of analyzing pore connectivity in such films. It is a further object of the invention to provide three-dimensional images of pore structure within microporous polyolefin films.

These and additional objects are provided by the present invention. In a first embodiment, the invention is directed to a method of analyzing pore structure in a microporous polyolefin film. The methods comprise applying a detectable material to one surface of a microporous polyolefin film, wherein the detectable material is capable of traveling through pores in the film, and focusing a confocal microscope at a depth within the film to obtain a first image of the detectable material within pores of the film at the depth within the film.

In a further embodiment, the invention is directed to methods of analyzing pore structure in a microporous polyethylene film, which methods comprise applying a detectable dye to one surface of a microporous polyethylene film, focusing a confocal microscope at a plurality of depths within the film to obtain a plurality of images of the dye within pores of the film at the plurality of depths within the film, focusing the confocal microscope at the other surface of the film to obtain a surface image of the dye at the other surface, and aligning the obtained images to create a three-dimensional image of pore structure through the film.

In a further embodiment, the invention is directed to three-dimensional images of pore structure within a microporous polyolefin film. The three-dimensional images comprise a plurality of aligned confocal microscope images, wherein each confocal microscope image comprises a two-dimensional image of pore structure at a depth within the film. In yet a further embodiment, the invention is directed to three-dimensional images of pore structure within a microporous polyethylene film comprising a calcium carbonate filler. The three-dimensional images comprise a plurality of aligned confocal microscope images, wherein each confocal microscope image comprises a two-dimensional image of pore structure at a depth within the film, and the pore structure in each two-dimensional image is represented by a detectable dye.

The present invention is advantageous in providing visualization of pore structure, and importantly, pore connectivity, in microporous polyolefin films. Accordingly, the present invention may be used to tailor the design and production of microporous polyolefin films for specific applications. Additional objects, embodiments and advantages of the present invention will be more fully apparent in view of the following drawings and detailed description.

### BRIEF DESCRIPTION OF THE DRAWINGS

The present invention may be further understood in view of the drawings in which:

FIG. 1 sets forth a schematic diagram of a confocal microscope suitable for use in the methods of the present invention;

FIGS. 2A and 2B schematically represent experimental methodology which may be employed in obtaining images within a film and at the surface of a film, respectively, in accordance with specific embodiments of the methods of the invention;

FIGS. 3A-3E set forth a series of two-dimensional images obtained in accordance with a method according to the present invention; and

FIG. 4 sets forth a schematic representation of an alignment step which may be employed in specific embodiments of the methods of the invention.

These Figures should be considered as illustrative only and not limiting of the various embodiments according to the present invention, which will be more fully understood in view of the following detailed description.

### DETAILED DESCRIPTION

The present invention is directed to methods of analyzing pore structure in microporous polyolefin films, and three-dimensional images of such pore structures. Polyolefin polymers which may be employed in compositions used to form the microporous films for use in the present methods and images include, but are not limited to, polyolefins and/or functionalized polyolefins, examples of which include, but are not limited to ultra low density polyethylene (ULDPE), low density polyethylene (LDPE), linear low density polyethylene (LLDPE), medium density polyethylene (MDPE), high density polyethylene (HDPE), polypropylene, and the like. The compositions may comprise homopolymers and/or copolymers of these polymers. The copolymers may include olefin and/or non-olefin monomer components, and examples include, but are not limited to, polyethylene and polypropylene copolymers with C4-C8 alpha-olefin monomers, including 1-octene, 1-butene, 1-hexene and 4-methyl pentene, poly(ethylene-vinylacetate), poly(ethylene-methylacrylate), poly(ethylene-acrylic acid), poly(ethylene-butylacrylate), poly(ethylene-propylenediene), and ethylene-propylene rubber, and/or polyolefin terpolymers thereof, for example, poly(styrene-butadiene-styrene), poly(styrene-isoprene-styrene), poly(styrene-ethylene-butylene-styrene). The polyolefins may be substantially linear or branched, and may be formed by various processes known in the art using catalysts such as Ziegler-Natta catalysts, metallocene catalysts or others widely known in the art. Additionally, the compositions may also include one or more nonolefin based polymers, if desired.

Suitable fillers for use in the films include, but are not limited to, various inorganic and organic materials, including, but not limited to, metal oxides, metal hydroxides, metal carbonates, organic polymers, derivatives thereof, and the like. Preferred fillers include, but are not limited to, calcium carbonate, diatomaceous earth, titanium dioxide, and mixtures thereof. In a more specific embodiment, the filler employed in the film composition comprises calcium carbonate. Calcium carbonate is typically available in average particle sizes ranging from about 0.1 micron to about 2.5 microns. Calcium carbonate in the lower average particle size ranges is typically formed by precipitation while calcium carbonate in the higher average particle size ranges is typically formed by grinding.

The filler may be provided with a surface coating, if desired. Suitable filler coatings are known in the art and include, but are not limited to, silicone glycol copolymers, ethylene glycol oligomers, acrylic acid, hydrogen-bonded complexes, carboxylated alcohols, ethoxylates, various ethoxylated alcohols, ethoxylated alkyl phenols, ethoxylated fatty esters, carboxylic acids or salts thereof, for example, stearic acid or behenic acid, esters, fluorinated coatings, or the like, as well as combinations thereof.

The amount of filler which is employed in the film may be varied in accordance with techniques know in the art. For example, while not intending to be limited by theory, it is believed that for a given constant permeability rate, higher concentrations of filler will, with most other variables constant, provide smaller maximum pore sizes, as the film is stretched less. Conversely, for a given constant permeability rate, a lower concentration of particles will provide a microporous film having a larger maximum pore size, as the film must be stretched more to achieve the target permeability rate. One skilled in the art will be able to determine a suitable amount of filler for a desired application. Typically, the filler will comprise from about 25 to about 75 weight percent of the composition.

The composition may further include conventional additives, including, but not limited to, pigments, opacifiers, processing aids, antioxidants, stabilizers (light, UV, heat, etc.), tackifiers, and/or polymeric modifiers, as desired.

The microporous films may be of any suitable thickness which provides desired properties, particularly breathability. Suitably, the microporous films will individually have a thickness of from about 0.1 mil to about 10 mils, more specifically from about 0.25 mil to about 5 mils. Additionally, the pores are of a size sufficiently small as to not be readily visible to the naked eye. Preferably, the pores are sufficiently small as to render the multilayer microporous film liquid impervious at atmospheric pressure conditions. In one embodiment, the multilayer microporous films have a maximum pore size in the range of about 0.01 to about 0.25 micron. In another embodiment, the multilayer microporous films exhibit a maximum pore size sufficiently small for the films to act as viral barriers, i.e., not greater than about 0.10 to about 0.12 micron. Advantageously, the multilayer microporous films will also exhibit good air and water vapor transmission. Typically, the films will exhibit a moisture vapor transmission rate (MVTR) of greater than about 500 g/m²/day. In more specific embodiments, the microporous multilayer films will exhibit MVTRs of greater than about 1500 g/m² day, greater than about 2500 g/m²/day, or greater than about 3000 g/m²/day, as measured according to ASTM E96E.

The film may be part of a composite material, for example in combination with additional film layers or one or more nonwoven layers. Suitable nonwoven fibrous layers or webs may comprise, but are not limited to, fibers of polyethylene, polypropylene, polyesters, rayon, cellulose, nylon, and blends of such fibers. A number of definitions have been proposed for nonwoven fibrous webs. The fibers are usually staple fibers or continuous filaments. As used herein “nonwoven fibrous web” is used in its generic sense to define a generally planar structure that is relatively flat, flexible and porous, and is composed of staple fibers or continuous filaments. Typically, such webs are spun bonded, carded, wet laid, air laid or melt blown. For a detailed description of nonwovens, see “Nonwoven Fabric Primer and Reference Sampler” by E. A. Vaughn, Association of the Nonwoven Fabrics Industry, 3d Edition (1992). Such nonwoven fibrous webs typically have a weight of about 5 grams per square meter to 75 grams per square meter, more specifically about 10 to about 40 grams per square meter, and may be combined with a film by extrusion lamination, adhesive lamination or other lamination techniques known in the art.

Typically, the film is rendered microporous by stretching. A number of different stretchers and techniques may be employed. For example, the film may be stretched by cross direction (CD) intermeshing, and/or machine direction (MD) intermeshing. In addition, CD intermeshing, and/or MD intermeshing, may be employed with machine direction orientation (MDO) stretching and/or CD tentering stretchers, in any desired order. Thus, in one embodiment CD intermesh stretching and/or MD intermesh stretching is performed first and followed by MDO stretching. In an alternate embodiment, MDO stretching is performed, optionally followed by CD intermesh stretching, and/or MD intermesh stretching. Additional variations thereof may also be used. Various specific techniques for these and other stretching techniques are known in the art and may be employed. Additionally, the films may be subjected to embossing prior to stretching, in accordance with embossing techniques generally known in the art.

The present invention is directed to methods of analyzing pore structure in a microporous polyolefin film and to three-dimensional images of pore structure within a microporous polyolefin film. The methods employ confocal microscopy and a detectable material which is capable of traveling through the pores in the film.

Several conventional porosity characterization methods have been used. The first conventional method typically measures air flow rate through a film. The second conventional method measures liquid flow through a film and employs bubble point techniques to estimate smallest and largest pore size. Finally, techniques have been developed for measuring moisture vapor transmission rates of water through film in order to characterize film porosity. The methods of the present invention provide improvement over these conventional methods.

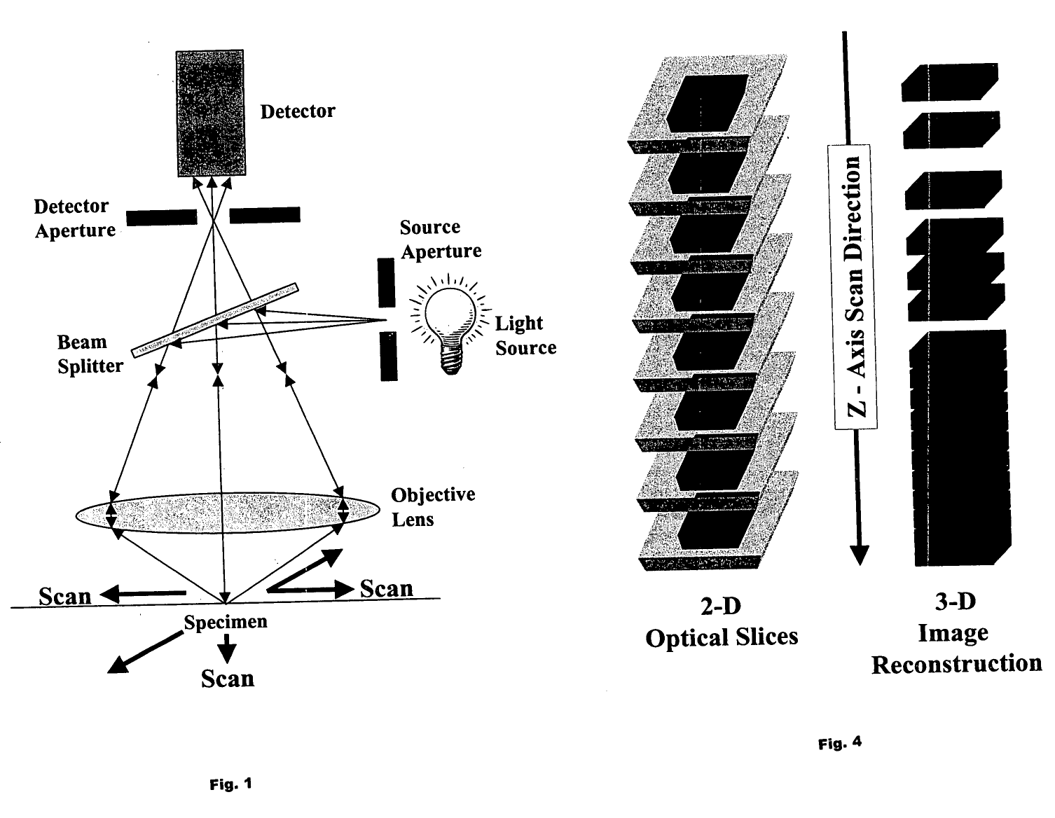

Confocal microscopes are known in the art and are commercially available for use in the present methods. FIG. 1 sets forth a schematic diagram of one embodiment of a confocal microscope suitable for use in the present methods. With reference to FIG. 1, a light source is directed through an aperture to a beam splitter which splits imaging radiation and directs the radiation to an objective lens though which the radiation is projected to scan a specimen, i.e., a film. Reflected radiation passes through the objective lens, the beam splitter and a detector aperture to a detector. A typical light source will comprise a scanning laser. As is known in the art, the confocal microscope can be focused at a depth within a material in order to scan detectable materials therein. An example of a commercially available confocal microscope comprises the Bio-Rad 1024. Confocal Microscope available from Bio-Rad Laboratories, Hercules, Calif. Other confocal microscopes are commercially available from various manufacturers, one of which includes Carl Zeiss, Ltd., Thornwood, N.Y., for example Model CSLM 10.

The detector is preferably coupled to a computer in order to produce digital images of the scanned material, in accordance with techniques known in the art. Preferably, a two-dimensional image, for example a two-dimensional digital image, of the scanned surface is produced.

The detectable material which is capable of traveling through pores in the film may be any such material which can penetrate through connecting pores in the microporous polyolefin film. The detectable material may travel through the pores by any mechanism including, but not limited to, adsorption, absorption, or the like. Additionally, the detectable material may be any material which is detectable by confocal microscopy. In one embodiment, the detectable material comprises a detectable dye, for example a fluorescent dye. Various fluorescent dyes are well known in the art and suitable for use in the present invention. One example comprises a rhodamine dye which exhibits a low photo bleaching (fading) fluorochrome effect. Typically, such a dye absorbs green light and emits red light. However, other fluorescent or detectable dyes or materials may be employed.

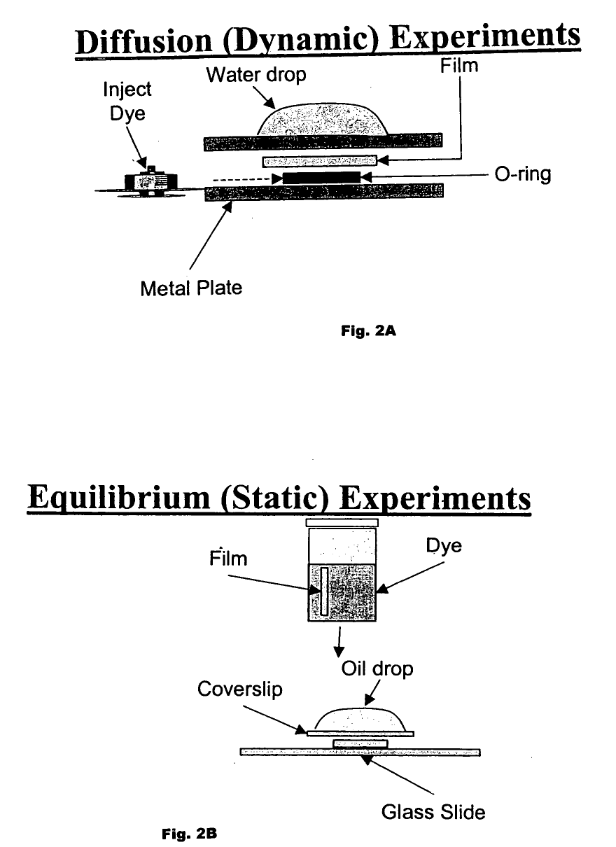

In accordance with the present methods, a detectable material is applied to one surface of the microporous polyolefin film. Typically, with reference to the manner in which the film is arranged for scanning by the confocal microscope, the detectable material, i.e., dye, is applied to the bottom surface of the film. Attention is directed to FIG. 2A which discloses a schematic diagram of the experimental methodology for preparation of the film for confocal microscope focusing and imaging. For example, the film is positioned over a metal base plate and an O-ring for retaining dye and is covered with a coverslip to which a water drop is applied. The microscope is focused at a depth within the film to obtain an image of the detectable material within pores of the film at the depth within the film at which the microscope is focused. In more specific embodiments of the invention, the microscope is focused at at least one additional depth to obtain at least one additional image of the detectable material within pores of the film at the at least one additional depth. In a further embodiment, the confocal microscope is focused at a plurality of additional depths within the film to obtain a plurality of additional images of the detectable material within the pores of the film at the plurality of additional depths.

In further embodiments, the microscope is focused at the one surface to which the detectable material is applied and/or the other surface of the film to obtain respective surface images of the detectable material at such surfaces. The surface images may be obtained by reflection, without the need of a detectable material as is employed in the pores. Alternatively, in yet a more specific embodiment, an image of the one surface to which the detectable material is applied, i.e., the bottom surface in FIG. 2A, may be obtained by applying an additional detectable material to the surface, wherein the additional detectable material is not capable of traveling through pores in the film. This allows the bottom surface to be clearly established in the image. For example, the additional detectable material may be comprise detectable particles, for example, fluorescent particles, of a size which prevents their travel through pores in the film. FIG. 2B discloses the experimental methodology for such a step wherein a dye with sufficiently large fluorescent particles therein is applied to the bottom surface of the film. The film is then placed on a glass slide and covered with a coverslip and oil drop in preparation for microscopic examination.

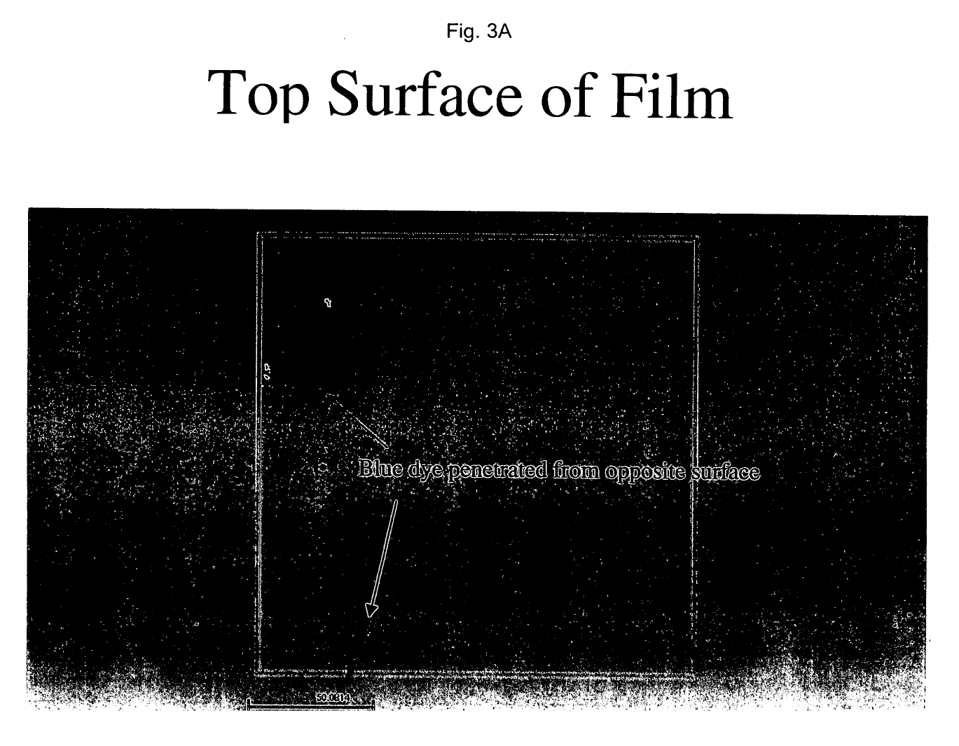

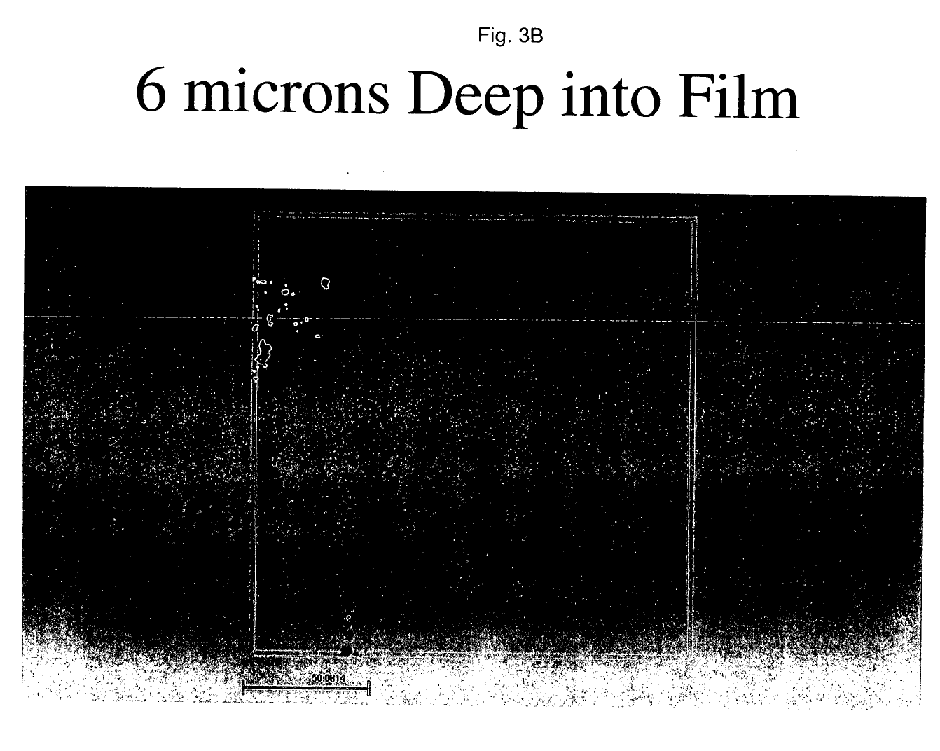

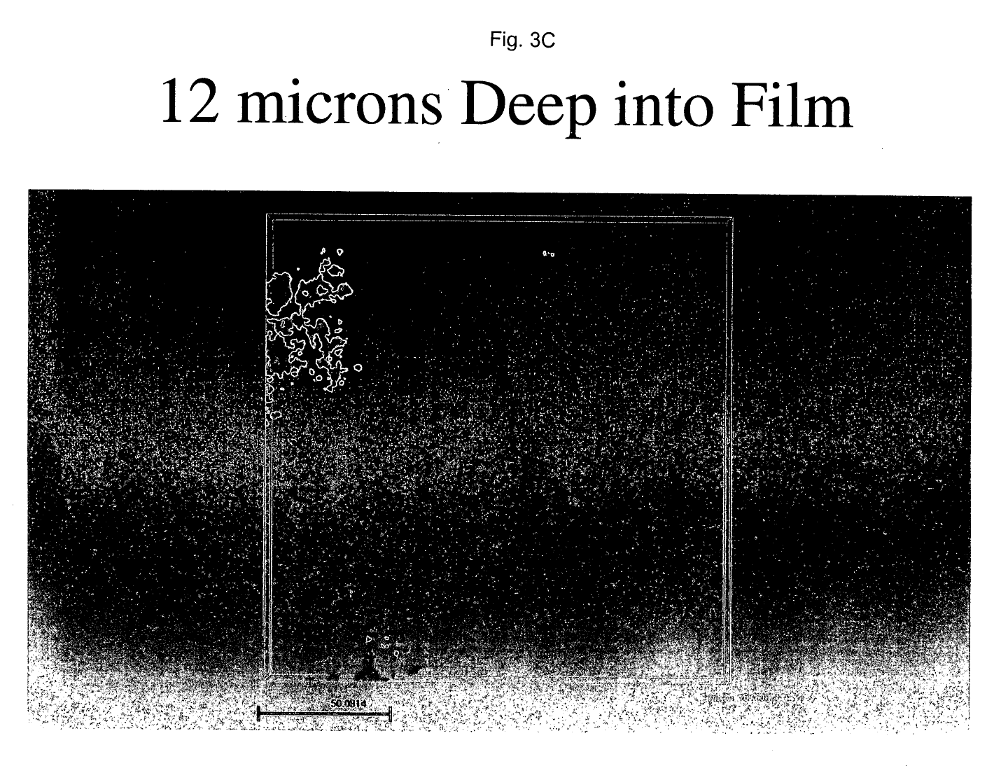

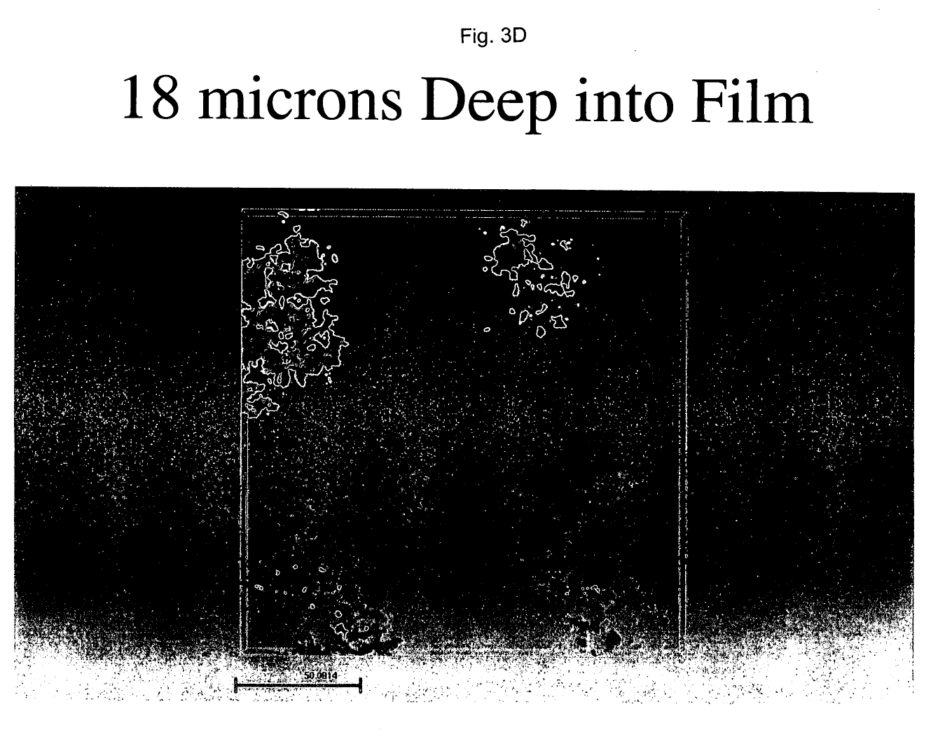

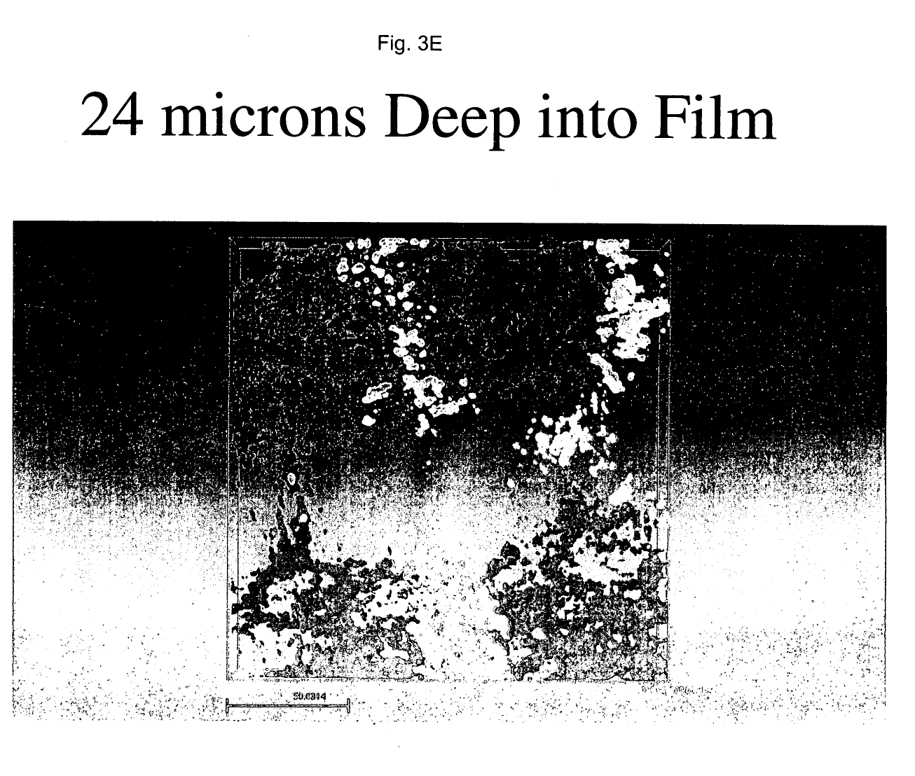

FIGS. 3A-3E disclose a series of digital images obtained according to the methods as described herein. FIG. 3A shows the top surface of a film, i.e., the surface opposite to the surface to which the detectable material, i.e., blue dye, was applied. The blue dye appearing at the film surface indicates the presence of pores which are in fluid communication with the bottom surface of the film. FIG. 3B shows the image obtained at a depth of 6 microns from the top surface of the film and indicates additional penetration of the dye from the bottom surface to pores at the indicated depth. FIGS. 3C-3E disclose the images obtained at depths of 12, 18 and 24 microns, respectively, and show increased pore connectivity at increasing depths through the film. These images are two-dimensional images of selected planes within the film material. The pore structure which exhibits connectivity with the bottom surface is represented by the detected dye in each image.

In a further embodiment of the present methods, the obtained two-dimensional images are aligned to form a three-dimensional image. The term “three-dimensional image” is used herein to mean an image having x, y and z-axis representation. Typically, the three-dimensional images will be provided in digital form and are provided by aligning the plurality of two-dimensional images in a third direction, for example images representing planes defined by x and y axes are aligned in the z direction. This alignment is shown schematically in FIG. 4. The alignment of the two-dimensional images to form a three-dimensional image can be done by commercially available digital processing software. One example of suitable software comprises Amira software available from Indeed Visual Concepts GmbH.

The specific and exemplary embodiments of the methods and images according to the invention set forth herein are illustrative in nature only and are not intended to be limiting of the inventive methods and images. Additional embodiments of the invention within the scope of the claimed invention will be apparent to one of ordinary skill in the art in view of the present disclosure.

What is claimed is:

1. A method of analyzing pore structure in a microporous polyolefin film, comprising applying a detectable material to one surface of a microporous polyolefin film wherein the detectable material is capable of traveling through pores in the film; and focusing a confocal microscope at a depth within the film to obtain a first image of the detectable material within pores of the film at the depth within the film.

2. The method according to claim 1, further comprising focusing the confocal microscope at at least one additional depth within the film to obtain at least one additional image of the detectable material within pores of the film at the at least one additional depth.

3. The method according to claim 2, further comprising focusing the confocal microscope at the one surface to obtain a first surface image.

4. The method according to claim 3, wherein an additional detectable material which is not capable of traveling through pores in the film is applied to the one surface prior to focusing of the confocal microscope on the one surface.

5. The method according to claim 4, wherein the additional detectable material comprises detectable particles of a size which prevents their travel through pores in the film.

6. The method according to claim 3, further comprising focusing the confocal microscope at the other surface of the film to obtain a second surface image of the detectable material at the other surface.

7. The method according to claim 2, further comprising focusing the confocal microscope at the other surface of the film to obtain a surface image of the detectable material at the other surface.

8. The method according to claim 1, further comprising focusing the confocal microscope at a plurality of additional depths within the film to obtain a plurality of additional images of the detectable material within pores of the film at the plurality of additional depths.

9. The method according to claim 8, further comprising aligning the first image and the plurality of images to create a three dimensional image of pore structure through the film.

10. The method according to claim 1, wherein the detectable material is a fluorescent dye.

11. The method according to claim 1, wherein the polyolefin comprises polyethylene.

12. The method according to claim 11, wherein the polyethylene comprises a filler.

13. The method according to claim 12, wherein the filler comprises calcium carbonate.

14. A method of analyzing pore structure in a microporous polyethylene film, comprising applying a detectable dye to one surface of a microporous polyethylene film; focusing a confocal microscope at a plurality of depths within the film to obtain a plurality of images of the dye within pores of the film at the plurality of depths within the film; focusing the confocal microscope at the other surface of the film to obtain a surface image of the dye at the other surface; and aligning the obtained images to create a three dimensional image of pore structure through the film.

15. A three dimensional image of pore structure within a microporous polyolefin film, comprising a plurality of aligned confocal microscope images, wherein each confocal microscope image comprises a two dimensional image of pore structure at a depth within the film.

16. The three dimensional image according to claim 15, wherein the pore structure in each two dimensional image is represented by a detectable dye.

17. The three dimensional image according to claim 15, wherein the polyolefin comprises polyethylene.

18. The three dimensional image according to claim 17, wherein the polyethylene comprises a filler.

19. The three dimensional image according to claim 18, wherein the filler comprises calcium carbonate.

20. A three dimensional image of pore structure within a microporous polyethylene film comprising a calcium carbonate filler, the three dimensional image comprising a plurality of aligned confocal microscope images, wherein each confocal microscope image comprises a two dimensional image of pore structure at a depth within the film and wherein the pore structure in each two dimensional image is represented by a detectable dye.
